(19) United States
(12) Patent Application Publication
(10) Pub. No.: US 2010/0094695 A1
(43) Pub. Date: Apr. 15, 2010

(54) AFFILIATE CONSUMER REFERRAL MARKETING

(76) Inventor: Leonard J. GAIK, Hamilton (CA)

Correspondence Address: DIMOCK STRATTON LLP, 20 QUEEN STREET WEST, 32nd FLOOR, BOX 102, TORONTO, ON, M5H 3R3, CA

(21) Appl. No.: 12/576,719

(22) Filed: Oct. 9, 2009

Related U.S. Application Data
(60) Provisional application No. 61/104,522, filed on Oct. 10, 2008.

(51) Int. Cl. G06Q 30/00; G06Q 20/00; G06F 3/01

(52) U.S. Cl. 705/14.16; 715/760

(57) ABSTRACT

This invention relates to an affiliate website that provides incentives to users to follow links from that website to merchant websites to perform referral fee paying activities, and to recruit their own network of users that will also be incentivized to follow links from that website to merchant websites to perform referral fee paying activities. All users can recruit others to join the affiliate website. A portion of the referral fees paid by the merchant website to the affiliate website are paid by the affiliate website to the user that performed the fee paying activity and to others in the network to which that user is a member.

### FIELD OF THE INVENTION

This invention relates to commissioned sales incentives. In particular, the invention relates to providing incentives for purchasing and referring others to a sales platform.

This invention relates to affiliate website referral fee incentives. In particular, the invention relates to providing incentives for users to join a website, recruit other users to join the website, and to undertake activities that will cause merchant websites to pay referral fees to the affiliate website and users.

### BACKGROUND OF THE INVENTION

There currently exist incentive programs referred to as Affiliate Programs whereby Merchant Websites enter into agreements with Affiliate Websites that may be other websites, e-newsletters and/or web blogs, whereby the Merchant Websites pay fees to the Affiliate Website in respect of various activities on the Merchant Website of people that clicked through to it from the Affiliate Website. Examples of payments made from the Merchant Website to the Affiliate Website include (a) payments to the Affiliate Website by the Merchant Website for stipulated quantities of people that click through to the Merchant Website from the Affiliate Website, (b) sales commissions paid to the Affiliate Website by the Merchant Website on purchases made by people that click through to the Merchant Website from the Affiliate Website, and (c) payments to the Affiliate Website by the Merchant Website for completion by people that click through to the Merchant Website of information requested on the Merchant Website. A Fee Paying Activity typically occurs when a person browses the Affiliate Website, clicks through from the Affiliate Website to a Merchant Website, and conducts any activities on the Merchant Website which cause the Merchant Website to pay Referral Fees to the Affiliate Website.

In some systems, Sub-Affiliate Websites are utilized. A Sub-Affiliate Website is typically a webpage(s) embedded within or linked to an Affiliate Website. By way of example, a person's user-generated Facebook page(s) on www.facebook.com could be a Sub-Affiliate Website to the Facebook Affiliate Website. With the Sub-Affiliate Website system, a Merchant Website may pay the Affiliate Website and/or the Sub-Affiliate Website, or alternatively, the Affiliate Website will receive all of the Referral Fees and remit a portion to the Sub-Affiliate Website. Because the principles are similar, references to Sub-Affiliate Website and Affiliate Website may be used interchangeably in most contexts.

### Deficiencies of Existing Affiliate Programs: Lack of Consumer Income Participation

There are multiple deficiencies and failings associated with current Website Affiliate programs. First, while each of the Merchant Website and Affiliate Website typically derive economic gain via the Fee Paying Activities of consumers, the consumer rarely if ever receives an overt cash share of the Referral Fees, even though it is the consumer's Fee Paying Activities (including, primarily, consumer purchases) that fund the Referral Fees paid by the Merchant Website to its Affiliate Website. Sometimes a consumer is provided with other incentives, such as product or service discounts or other non-monetary rewards from a Merchant Website, but such incentives are not income, and are typically outside of the Merchant Website/Affiliate Website Referral Fee system.

### Deficiencies of Existing Affiliate Programs: Affiliate Websites Require Desirable Content to Attract Traffic

Another deficiency of existing website Affiliate Programs, is that in order for an Affiliate Website to generate Referral Fee income, the Affiliate Website needs to generate website traffic for itself and have that traffic link to the Merchant Website and undertake Fee Paying Activities. Generally there is a relation between the number of visitors to an Affiliate Website and the number of such visitors that will click through to a Merchant Website and undertake Fee Paying Activities. For example, an Affiliate Website with one million visitors per day could reasonably be expected to generate more user click-throughs to Merchant Websites and therefore, more Referral Fees, than an Affiliate Website with ten visitors per day.

Generating consumer traffic to an Affiliate Website is therefore a common goal of Affiliate Websites. Consumer traffic is also typically linked to the quantity of content, and the amount of interest in the content, on the Affiliate Website. The less quantity of content, or interest in the content on an Affiliate Website, the fewer the number of people that will visit that Affiliate Website. This will typically result in less Fee Paying Activities and Referral Fees paid to that Affiliate Website. Unfortunately, acquiring and/or developing content for any website is a creatively and financially challenging endeavor.

### Deficiencies of Existing Affiliate Programs: The Limiting Effect of the Nature of Website Content on Potential Referral Fees

Another deficiency of existing website Affiliate Programs, arises from the relationship between the subject matter of the Affiliate Website and the subject matter of the Merchant Website. The number of people clicking through from an Affiliate Website to a Merchant Website is typically related to the relevance of the Merchant Website's goods and/or services to the person browsing the Affiliate Website's content. By way of example, an Affiliate Website focused on renovation and home improvement would reasonably be expected to generate more click-throughs to, and therefore more Referral Fees from, Merchant Websites for hardware and tool suppliers, than would an Affiliate Website whose content focuses on travel adventure. Since it is typically preferred that Affiliate Websites be relevant to the consumers, products and services targeted by the Merchant Websites in order to instigate click throughs to those Merchant Websites, such Affiliate Websites will consequently have a more narrowly focused target market than a website targeted at the general population. As a further example, consumers on a medical health website are more likely to click through to health-related Merchant Websites than to industrial equipment Merchant Websites. This target market characteristic of Affiliate Websites has a limiting factor on the potential number of people browsing the Affiliate Website and therefore the number of click-throughs from that Affiliate Website to Merchant Websites.

### Deficiencies of Existing Affiliate Programs: Entities Without a Web Presence Do Not Earn Referral Fees

A further deficiency of website Affiliate Programs, is that a person or entity that does not wish, or does not have the resources, to develop an Affiliate Website, from which another person can click through to a Merchant Website, will not be able to earn any Referral Fees. A consumer without their own Affiliate Website will not be able to participate and earn money in any website Affiliate Programs. If such a person or entity nonetheless is in contact with a large network of people and/or other entities and is otherwise capable of referring other people for the purchase of goods and/or services, an opportunity for a share of Referral Fees is not realized by such person or entity.

In addition to website Affiliate Programs, there currently exist marketing programs referred to generally as Network Marketing. Network Marketing refers to a marketing program which sells products or services via a network of persons or other entities. The fundamental characteristic of a Network Marketing program is that a person selling the program's goods or services, usually called a Sales Representative, can earn income as Sales Commissions on both (i) their sale of the program's goods and/or services, and (ii) from the sale of goods and services by persons which that Sales Representative has recruited to the program, termed Recruits, and from the sale of goods and/or services by persons that those Recruits recruit to the program, and so on. Sales Commissions generated by Recruits networked under a Sales Representative are generally referred to as Shared Commissions. In some Network Marketing programs, Sales Representatives are also paid a fee for each of their Recruits. The calculation of the Sales Commissions and the Shared Commissions, including the breadth and depth of Recruits permitted for inclusion in such calculation, varies by the Network Marketing program.

There a multiple deficiencies associated with existing Network Marketing programs. In order for a Sales Representative to earn income via the program, that Sales Representative must: (i) sell the Network Marketing programs' goods and/or services; (ii) secure Recruits; and/or (iii) have Recruits sell the Network Marketing programs' goods and/or services. In addition to that burden of selling and recruiting, Sales Representatives are customarily required to: (a) purchase an inventory of goods from the program for resale; (b) to pay for membership fees for joining the program; and/or (c) to pay for sales training and/or paraphernalia for the program. There is therefore, the risk that if a Sales Representative fails to resell sufficient goods and/or secure a sufficient number of Recruits, they will suffer a financial loss in the program. The burdens of selling, securing recruits, and risk of financial loss on inventories and other required expenses, make Network Market programs unacceptable to many people.

There is a need for a system that provides for an Affiliate Website which provides a user with incentives to earn income by sharing in Referral Fees paid in relation to Fee Paying Activities that he/she would in any event be conducting on the internet but not otherwise earning income on, by merely registering with the Affiliate Website and clicking through to Merchant Websites to undertake those Fee Paying Activities on the Merchant Website(s). In such a system a Registrant would not have to build an Affiliate Website in order to so earn a share of Referrals Fees paid.

There is a further need for a system that through combination of Referral Fees and a Registrant network, the income potentially earned by a Registrant, from the sharing of Referral Fees paid to the Affiliate Website can grow exponentially via the Fee Paying Activities that layers of people and entities in his/her Registrant network (i.e. his/her Recruits) would in any event be undertaking on the internet, but that would not otherwise earn income for the Registrant. In such a system, the fees paid can be earned regardless of whether the Registrant himself or herself undertakes any Fee Payable Activities.

There is also a need for a system that through the invention's combination of sharing Referral Fees with the Registrant network, a Registrant will have incentives to earn income for the other people and entities in the Registrant network between the registrant and the Affiliate Website, which is generally referred to as his/her Upline, by causing Referral Fees to be paid and shared with his/her Upline, on the Registrant's Fee Paying Activities which he/she would in any event be conducting on the internet, but on which he/she would not otherwise earn income for his/her Upline.

There is a need for a system that provides benefits to all Registrants without them incurring any expense other than their own elected consumption of goods or services though Merchant Websites, such as purchasing resalable inventories, incurring expenses in relation to building their own Affiliate Website, or themselves having to sell any goods or services. In other words, Registrants may obtain the benefits of the affiliate program through activities many people customarily perform economic activities, such as shopping, on the internet. A person would be able to earn income for themselves, earn income for other people they are connected to, and earn income from other people they are connected to, merely by such group of connected people registering with and conducting their online shopping, through the Affiliate Website.

There is a further need for a system that permits the Affiliate Website to be able to earn a share of Referral Fees without incurring much, if any, expense in relation to developing or acquiring creative or factual content or itself acquiring, manufacturing, marketing, distributing or selling any goods or services. By being able to generate income from Referral Fees while not having to develop or acquire creative or factual content aimed at a particular target market (i.e. home renovation, health care, etc.) or acquire, manufacture, market, distribute or offer for sale its or any other party's goods or services (i.e. home renovation goods and services, medicines, etc.), the scope of public appeal of the Affiliate Website would not be narrowed by targeting of any one market. This would permit the Affiliate Website to appeal to any and all persons and entities that may browse and conduct Fee Paying Activities on the internet.

### BRIEF DESCRIPTION OF THE DRAWINGS

In drawings which illustrate by way of example only a preferred embodiment of the invention,

FIG. 1 is a schematic diagram of an example of an embodiment of the invention.

FIG. 2 is a representation of an example website of an embodiment of the invention.

FIG. 3 is a schematic diagram of a preferred embodiment of the invention.

FIG. 4 is a block diagram of a system embodying the invention.

### DETAILED DESCRIPTION OF THE INVENTION

In the preferred embodiment an alpha affiliate website 10, is linked to one or more merchant websites. The alpha affiliate website 10 is registered as an affiliate for each of the linked merchant websites 20a, 20b . . . 20n (collectively 20) and receives referral fees for fee paying activities performed at the merchant website 20 by people arriving at the merchant website from the alpha affiliate website.

Alpha affiliate website 10 registers as an affiliate with each of the linked merchant websites 20 by entering in to an agreement or contact with each of the merchant websites 20. The links between the alpha affiliate website 10 and the merchant websites 20 can be done by any means allowed under the agreement, including hyperlinks, banner ads, pop-up windows and other advertisements. The alpha affiliate website 10 may include a listed index, directory or search listings to locate links to the merchant websites 20.

The alpha affiliate website 10 has registered any number of registrants 40. Registrants may be individuals or other entities, such as organizations, fundraising bodies or other groups. They become registrants by entering into an agreement with the alpha affiliate website 10 and receiving a unique identifier. This unique identifier is used to identify which registrant 40 visits the alpha affiliate website 10 and links to which merchant website 20.

The affiliate agreements between the merchant websites 20 and the alpha affiliate website 10 provide that the merchants pay a referral fee to the alpha affiliate website 10 for fee paying activities performed by registrants 40 when they link to the merchant websites 40 from the alpha affiliate website 10. The referral fees obtained by the alpha affiliate website 10 can be associated with the registrant 40 that performed the specific fee paying activity that resulted in the referral fee. One way to associate fee paying activity to specific registrants is by tracking which registrant follows which link to the merchant website 40. This may be done by requiring registrants to log-in to the alpha affiliate website 40 using an identifier such as a username/password or automated tracking means such as a web browser ‘cookie’ that is saved on registrant's computer.

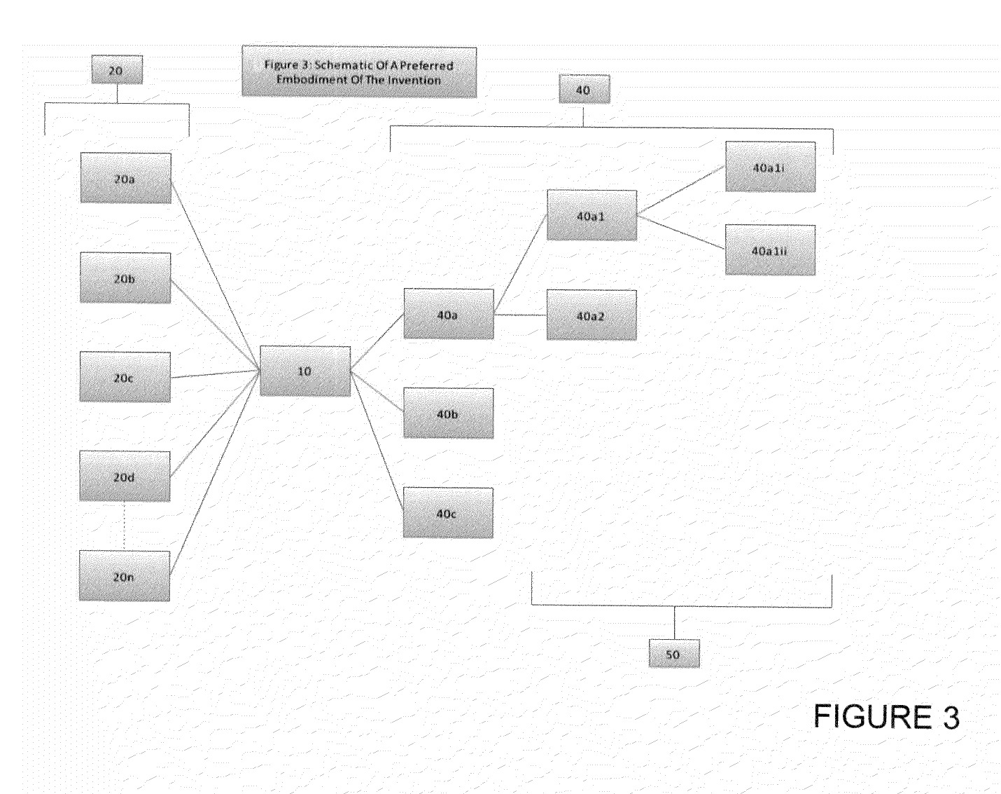

The alpha affiliate website 10 preferable allows for recruits 50, individuals or organizations recruited by a registrant 40. Each recruit 50 is associated with the registrant 40 that recruited the recruit 50. In addition, each recruit 50 may recruit additional recruits 50 which are associated with the recruit 50 that recruited them. A recruit 50 may be recruited through any means allowed by the alpha affiliate website 10 such as by email, social networking websites, in person, or through other websites. The collection of recruits, their recruits, their recruits, and so on is referred to as a registrant's network. As an example, in FIG. 3, registrant 40a may recruit registrant 40a1 and registrant 40a2. Registrant 40a1 may in turn recruit registrant 40a1i and registrant 40a1ii. The network for registrant 40a includes registrant 40a1, registrant 40a2, registrant 40a1i and registrant 40a1ii and any other registrant recruited by one of these registrants. A registrant's ‘upline’ includes all registrants in the lineage between the registrant and the registrants that recruited the registrant. Again, using the example shown in FIG. 3, the ‘upline’ for registrant 40a1i is registrant 40a1 and registrant 40a.

Since recruits and registrants use the alpha affiliate website 10 in similar ways, in many contexts recruit and registrant will be used interchangeable.

The alpha affiliate website 10 retains a portion of the referral fees obtained from the merchants 20. The remaining portion is paid to the registrant that performed the fee paying activity. In a preferred embodiment, a portion of the referral fee is also paid to the upline of the registrant that performed the fee paying activity. In this way a registrant may receive a portion of the referral fee for fee paying activity performed by anyone in the registrant's network.

The alpha affiliate website 10 may allow registrants to accumulate the referral fees at the alpha affiliate website 10 as part of their account or pay the fees to registrant. Either accumulated fees or each fee may be paid to registrants using an electronic money service such as electronic funds transfer, PayPal or by non-electronic means, such as a cheque or cash.

The division of the referral fee between the alpha affiliate website 10, the registrant and the registrant's upline can be determined by the alpha affiliate website 10.

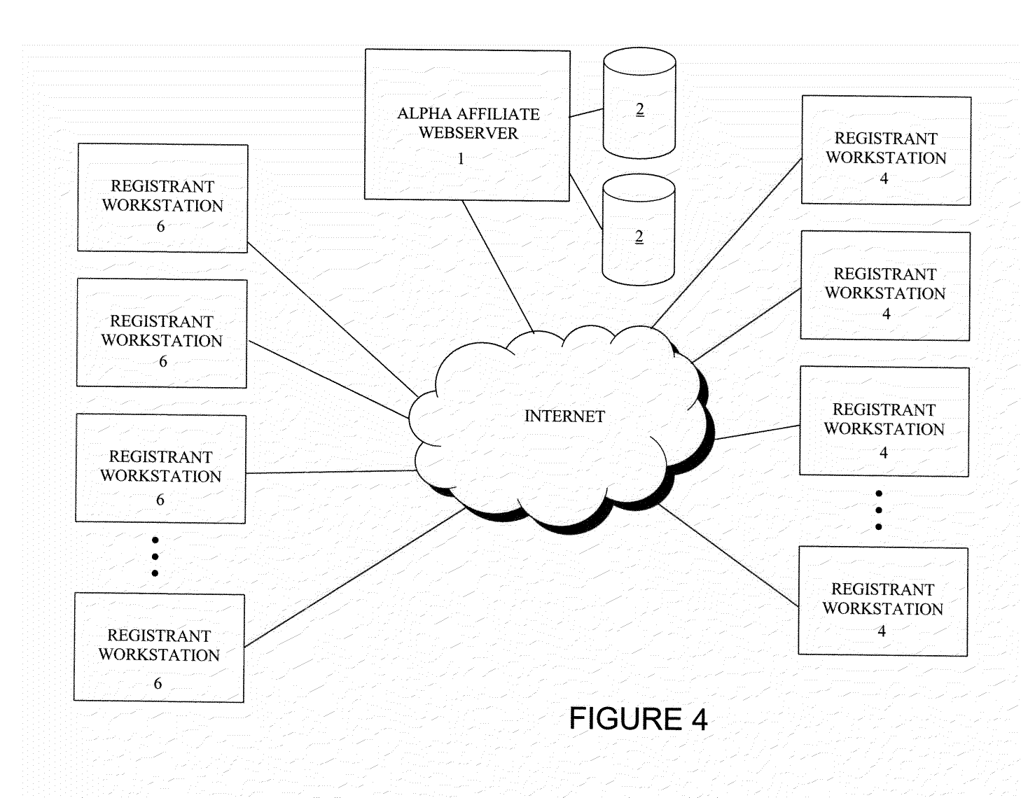

The alpha affiliate website 10 may be built from one or more webservers 1, the webserver 1 being a combination of hardware, such as computer and software, web server software. The webserver 1 may be connected to one or more databases 2 on the same or separate computer. The databases 2 may be used to track which registrant or recruit follows which link to the merchant websites 4 and the composition of a registrant's network of recruits. The registrant or recruit may link to the websites from a registrant's workstation 6, such any suitable data processing device (for example a PC or mobile communications device), or an interactive television system, by way of example. The registrant's workstation 6 may communicate with the webserver 1 and merchant websites 4 over a computer network such as the Global Computer Network (Internet) using a convention IP protocol or other suitable protocol, as illustrated in FIG. 4.

In operation, the alpha affiliate website 10 will establish links to a number of merchant websites 20 and try to increase the number of registrants and recruits registered and using the alpha affiliate website 10. Since the alpha affiliate website 10 keeps a portion of each referral fee paid by the merchant, the alpha affiliate website 10 obtains money for its operating costs and preferable a profit. Since the registrants have an incentive to locate and recruit other registrants, the alpha affiliate website 10 is relieved of some of the advertising and marketing that may otherwise be required.

Registrants have an incentive to use the alpha affiliate website 10. Registrants obtain a portion of each referral fee when they use the alpha affiliate website 10 to link to merchant websites 20 and purchase product or services or perform other fee paying activity. They may obtain a portion of a referral fee using the alpha affiliate website for activity that they normally perform on the Internet, but not otherwise obtain income. Registrants also have an incentive to recruit others to use the alpha affiliate website 10 as part of their network since they obtain a portion of any referral fees obtained by recruits, preferably including recruits of recruits. In this way, a registrant can obtain fees for themselves and obtain fees for people they are connected to in their upline by doing their online shopping through the alpha affiliate website 10.

### Example

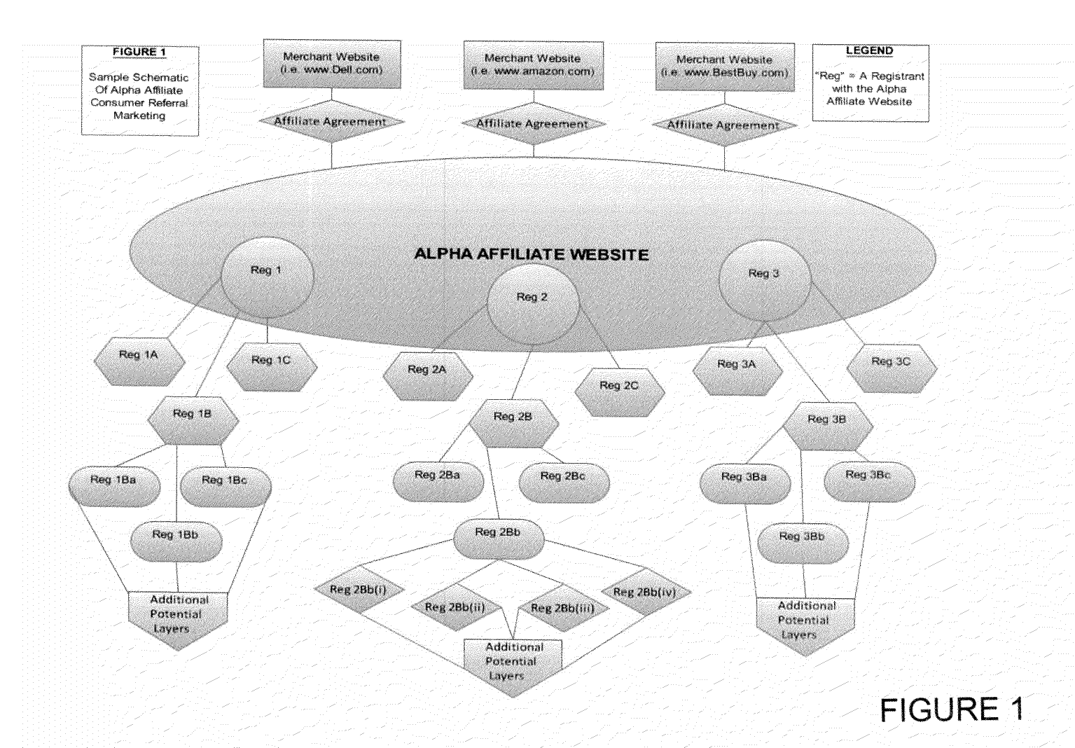

FIG. 1 shows one example of an embodiment of the invention. On the Alpha Affiliate Website 10 there would be links to various Merchant Websites 20. An agreement 22 between each of the Merchant Websites 20 and the Alpha Affiliate Website 10 would stipulate the payment of Referral Fees by the Merchant Websites 20.

When a user that is not yet a Registrant 40 browses onto the Alpha Affiliate Website 10, they would be invited to register by, among other things, creating a username and password. Each such user, once registered, would thereby become a Registrant 40 and would automatically be assigned a unique identifier. Once assigned this unique identifier, a Registrant 40 would either be prompted to log in whenever visiting the Alpha Affiliate Website 10 or be automatically logged in via recognition and tracking technology.

In this chosen example, Registrants 40a, 40b, 40c register with the Alpha Affiliate Website 10, without being recruited by an existing Registrant (i.e. registration of Registrants 40a, 40b and 40c was of their own volition). Registrant 40b, for example, then recruits Registrant 40b1, 40b2 and 40b3. The recruiting networks of Registrants 40a and 40c are also depicted on FIG. 1. In the example, Registrant 40b3 recruits Registrant 40b3i, 40b3ii, and 40b3iii. In the example, Registrant 40b3ii recruits Registrant 40b3iiA, 40b3iiB, 40b3iiC and 40b3iiD. Any of the Registrants could continue to recruit additional Registrants for their own Registrant networks, to the extent permitted by the Alpha Affiliate Website 10 rules of recruitment.

In the example shown in FIG. 1, the Upline for Registrant 40b3iiC, consists of Registrant 40b3ii, 40b3, 40b.

As one example of the use of the Alpha Affiliate Website 10, Registrant 40b3iiC could log into the Alpha Affiliate Website 10 before he shops for goods on one of the merchant websites 20, for example Amazon.com. He clicks through to the merchant website 20 a link on the Alpha Affiliate Website 10. When Registrant 40b3iiC undertakes a Fee Paying Activity on Amazon.com, Amazon.com will pay a Referral Fee to the Alpha Affiliate Website 10 in accordance with the affiliate agreement 22. The Alpha Affiliate Website 10 will retain a portion of that Referral Fee received and will share the remainder with Registrant 30b3iiC and the members of Registrant 40b3iiC′s Upline, which consists of Registrant 40b3ii, Registrant 40b3 and 40b. In this way, the Referral Fees payable as a result of a Registrant's Fee Paying Activities are shared among (i) the Registrant 40; (ii) its Upline; and (iii) the Alpha Affiliate Website 10.

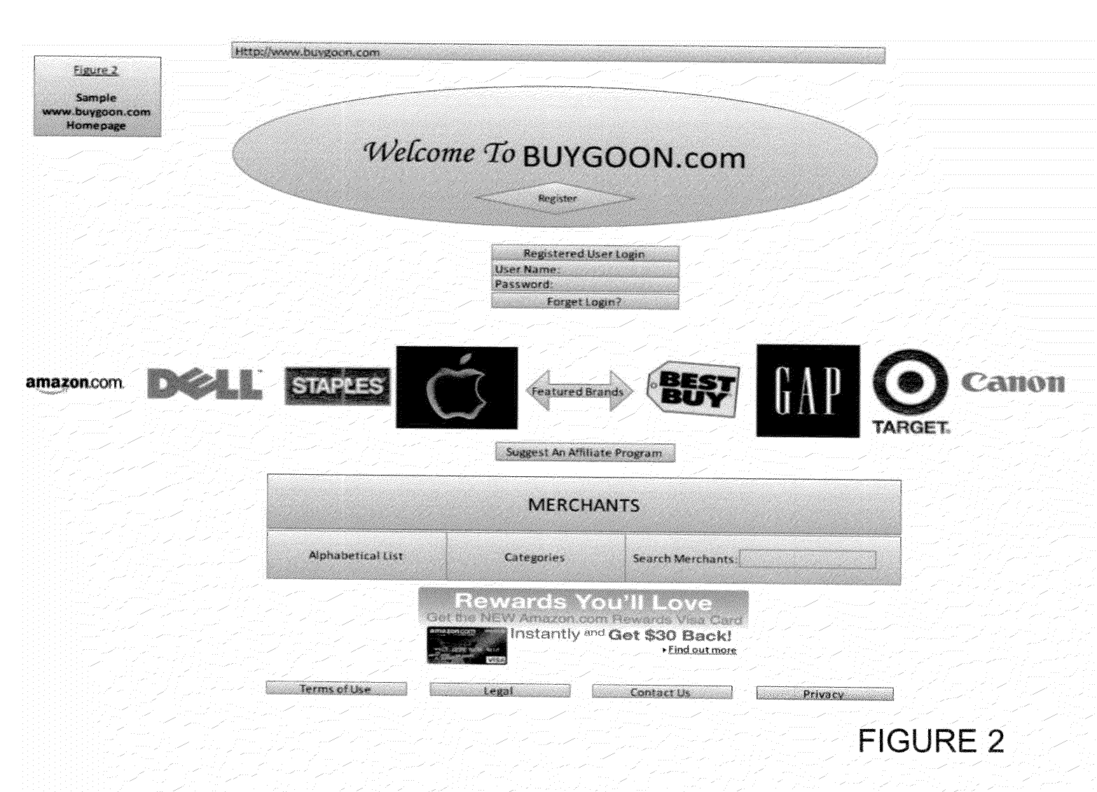

Further reference is made to FIG. 2, visually depicting a sample presentation of the Alpha Affiliate Website 10. In a preferred embodiment, the website includes a title 100 and a link 105 for new users to register as registrants. Registrants are able to log in to the Alpha Affiliate Website 10 using the username and password fields of the Registrant user login portion 110 of the website. The Alpha Affiliate Website 10 also preferable includes a list of links to merchant websites 20. This list may be arranged alphabetically or by categories as suggested in the ‘Merchants’ section 115 of the website. FIG. 2 also shows a set of preferred merchants 120 with direct links to the merchant websites 20. This preferred list of merchants may be selected by the Alpha Affiliate Website 10 based on popularity, by the amount of referral fees paid or some other criteria. The Alpha Affiliate Website 10 may also include advertising 125 and links to more information 130 about the Alpha Affiliate Website 10.

Various embodiments of the present invention having been thus described in detail by way of example, it will be apparent to those skilled in the art that variations and modifications may be made without departing from the invention.

I claim:

1. A website for connecting one or more registered users with merchant websites that pay fees for activities performed on the merchant website after following a link to a merchant website comprising:
for each merchant website, one or more links from the website to the merchant website;
associating each one or more registered user with the fee obtained from one of the merchant websites for activity performed by that registered user after following one of the links;
paying a portion of the fee paid by the merchant website associated with each of the one or more registered users to that registered user.

2. The website of claim 1, further comprising,
one or more recruits associated with one or more of the registered users;
associating each one or more recruit with the fee obtained from one of the merchant websites for activity performed by that recruit after following one of the links;
whereby a portion of the fee paid by the merchant website associated with each of the one or more recruits is paid to the registered user associated with the recruit and a portion of the fee paid by the merchant website associated with the recruit is paid to the recruit.

3. A method of compensating one or more users for purchases from merchants who pay referral fees comprising the steps of:
establishing links from an affiliate website to the one or more merchants;
registering the one or more users with the affiliate website;
receiving referral fees from the one or more merchants for activities performed by the one or more users after following the links;
paying a portion of the referral fees to the registered user associated with the activity for which the referral fee was received
